(19) United States
(12) Patent Application Publication
(10) Pub. No.: US 2013/0192393 A1
(43) Pub. Date: Aug. 1, 2013

(54) METER FOR READING MEASURED VALUES AT REMOTE DISTANCE

(71) Applicants: Hsin-Chen KO, New Taipei City (TW); Shang-Wen Chang, New Taipei City (TW); Win-Throng Chen, New Taipei City (TW)

(72) Inventors: Hsin-Chen KO, New Taipei City (TW); Shang-Wen Chang, New Taipei City (TW); Win-Throng Chen, New Taipei City (TW)

(21) Appl. No.: 13/358,937

(22) Filed: Jan. 26, 2012

(51) Int. Cl. G01D 7/02

(52) U.S. Cl. 73/866.3

(57) ABSTRACT

A meter for reading measured values at remote distance comprises a meter and an image reading device. A display screen for displaying measured values is disposed on the meter. The image reading device is coupled on the meter for capturing the measured values displayed on the display screen of the meter and transmitting the image to an external display device for a user to read or store at a remote distance.

### BACKGROUND OF THE INVENTION

1. Field of Invention

The present invention relates to a meter for reading measured values at remote distance, which is structurally simple and convenient to use.

2. Related Art

An avometer or a clamp meter is often used for measuring electric current and voltage. The meters are mainly classified into the electronic liquid crystal display (LCD) and the mechanical types. Besides that the display screens of typical meters look different, they are all equipped with a multi-sectional knob for switching between functions and with functional markings by the side so that a user can turn the knob to the required detecting functions.

Even though measurement can be performed and the values can be displayed clearly by the avometer or the clamp meter, the user has to hold the meter with a hand in any circumstances or applications during measuring, and the measuring and viewing of the measured data are done at the same time. Therefore, the user will have to hold the meter during the whole period of measuring or monitoring and other operations cannot be performed at the same time by the user. Even though the meter can be disposed at a location for continuous measuring, the user still has to go back and forth to the location to check on the measured data of the meter and it is rather inconvenient and troublesome.

### SUMMARY OF THE INVENTION

A primary object of the present invention is to provide a meter for reading measured values at remote distance, which is structurally simple and convenient to use.

In order to achieve the above-mentioned objects, a meter for reading measured values at remote distance of the present invention comprises a meter and an image reading device. A display screen for displaying measured values is disposed on the meter. The image reading device is coupled on the meter for capturing the measured values displayed on the display screen of the meter and transmitting the image to an external display device for a user to read or store at a remote distance.

In implementation, the image reading device comprises a photographing lens and a transmission line connected to the photographing lens. The photographing lens is disposed right above the display screen of the meter for capturing the measured values displayed on the display screen of the meter and transmitting the image to an external display device through the transmission line. The transmission line comprises a connecting interface for connecting to the display device. A shaft, which is rotatable freely, is disposed on the photographing lens.

In implementation, the image reading device further comprises a clamping element so that the image reading device can be clamped and fixed on the meter by the clamping element.

In implementation, the image reading device comprises a photographing lens, a flexible tube and a wireless transmission device. The photographing lens and the tube are connected with each other. The tube can be bent to an extent that the photographing lens can capture the measured values displayed on the display screen of the meter, and the image can be transmitted to an external display device through the wireless transmission device.

The present invention will become more fully understood by reference to the following detailed description thereof when read in conjunction with the attached drawings.

### BRIEF DESCRIPTION OF THE DRAWINGS

FIG. 1 is a perspective view of the present invention with a meter being an avometer;

FIG. 2 is an usage illustration of the present invention with the meter being an avometer;

FIG. 3 is a perspective view of the present invention with the meter being a clamp meter;

FIG. 4 is an usage illustration of the present invention with the meter being a clamp meter; and

FIG. 5 is an usage illustration of an image reading device of the present invention designed with a wireless transmission function.

### DETAILED DESCRIPTION OF THE INVENTION

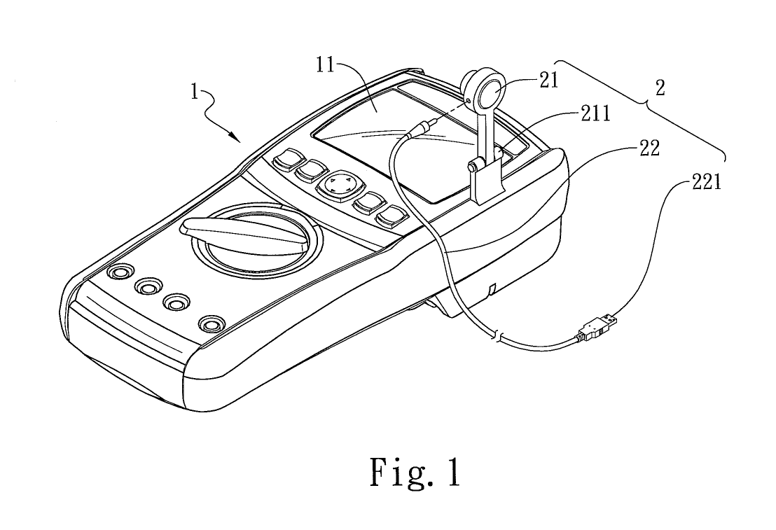

Referring to FIGS. 1 to 4, which are perspective views of a meter for reading measured values at remote distance according to an embodiment of the present invention. The present invention is composed of a meter 1 and an image reading device 2.

A display screen 11 for displaying measured values is disposed on the meter 1. The image reading device 2 is coupled on the meter 1 for capturing the measured values displayed on the display screen 11 of the meter and transmitting the image to an external display device 3 for a user to read or store at a remote distance.

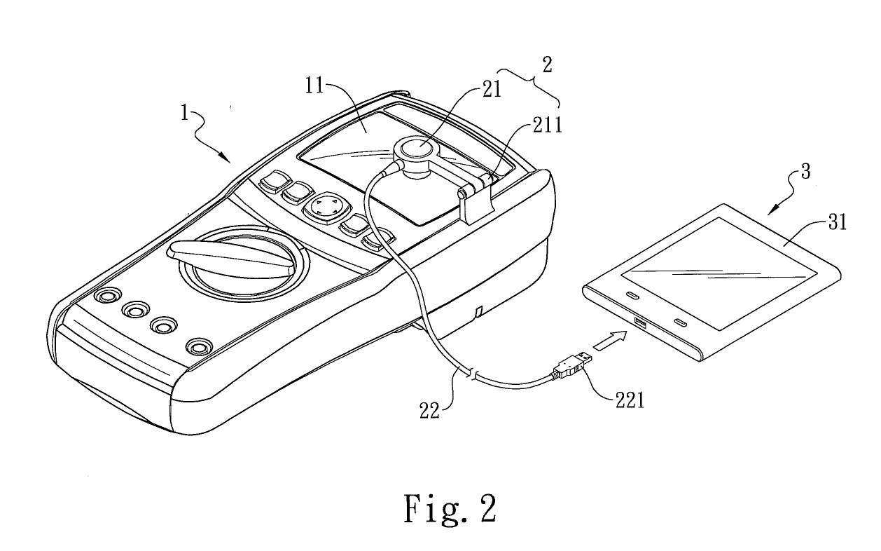

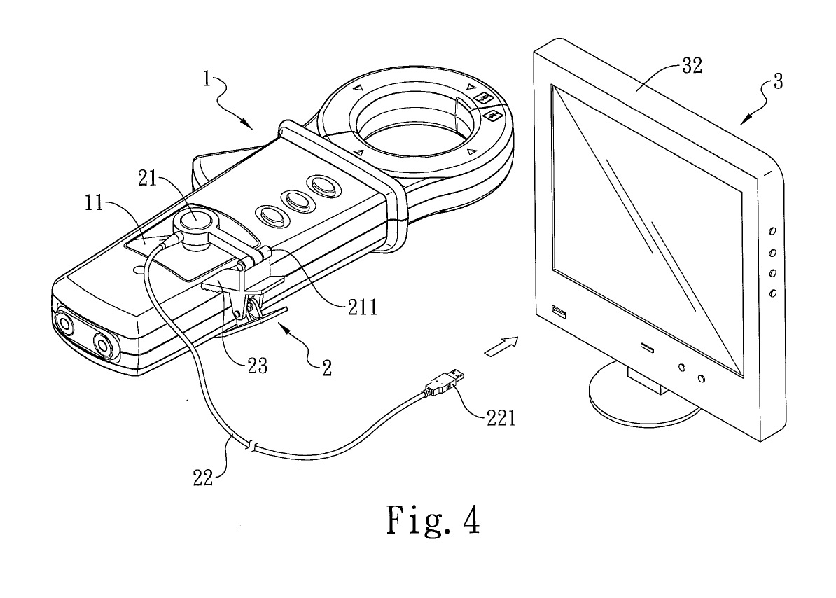

The image reading device 2 comprises a photographing lens 21 and a transmission line 22 connected to the photographing lens 21. A shaft 211 which can rotate freely is disposed on the photographing lens 21. The photographing lens 21 is disposed right above the display screen 11 of the meter 1 for capturing the measured values displayed on the display screen 11 of the meter 1 and transmitting the image to the external display device 3 through the transmission line 22. The external display device 3, for examples, can be a mobile phone 31 as shown in FIG. 2 or a computer screen 32 with displaying function as shown in FIG. 4. The transmission line 22 comprises a connecting interface 221 for connecting to the display device 3.

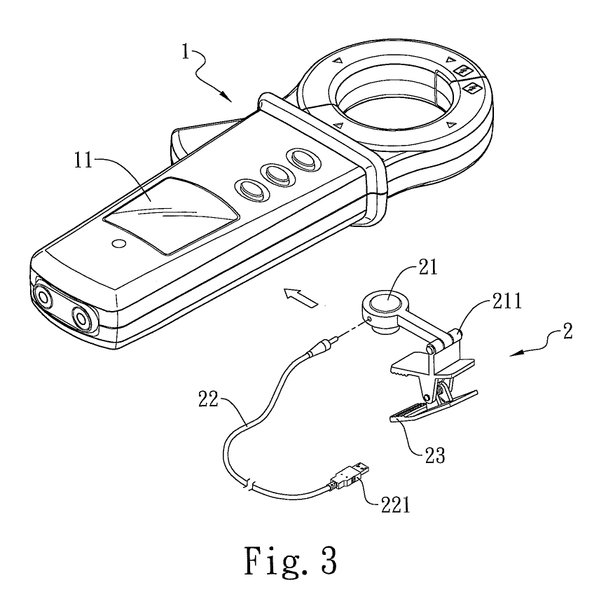

In implementation, the coupling of the image reading device 2 and the meter 1 is not limited to any particular methods, for examples, they can be permanently fixed together or movably fixed together such as by suction, clamping, adhering or engaging which are all included in the present invention. As shown in FIGS. 3 and 4, a clamping element 23 is disposed on the image reading device 2 so that the image reading device 2 can be clamped and fixed on the meter 1 by the clamping element 23.

Accordingly, no matter whether the meter 1 is an avometer shown in FIGS. 1-2 or a clamp meter shown in FIGS. 3-4, a meter for reading measured values at remote distance can be achieved when the meter 1 is coupled with the image reading device 2. When the present invention of the meter for reading measured values at remote distance is applied in continuous measuring or measuring of a lower location from a higher location, the image of the measuring data displayed on the display screen 11 of the meter 1 can be captured by the photographing lens 21 of the image reading device 2 and transmitted to the display device 3 through the transmission line 22. Therefore, the user is not required to be present at the location of the meter 1 and the measured data can be monitored or stored at a remote end at any time by the user through the external display device 3 that is convenient and practical.

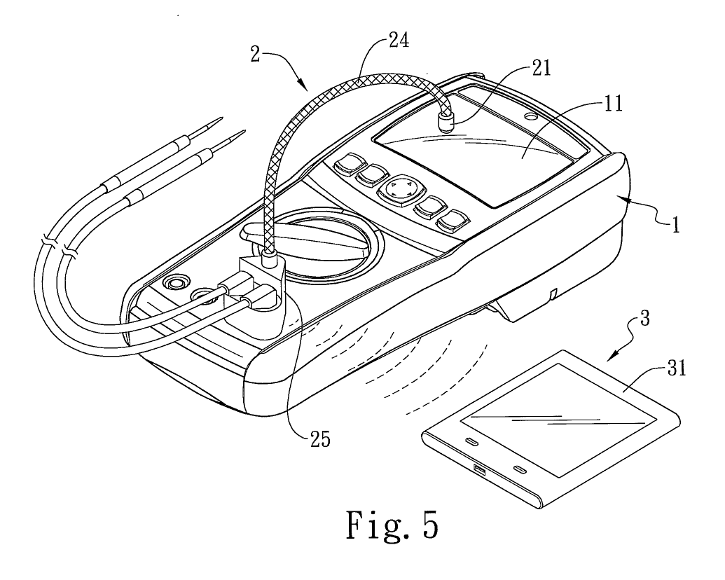

Furthermore, referring to FIG. 5, the image can be transmitted to the display device 3 by using the common wireless transmission technology. Therefore, the image reading device 2 can comprise the photographing lens 21, a flexible tube 24 and a wireless transmission device 25. The photographing lens 21 and the tube 24 are connected with each other. The tube 24 can be bent to an extent that the photographing lens 21 can capture the measured values displayed on the display screen 11 of the meter 1, and the image can be transmitted to the external display device 3 (e.g. the mobile phone 31) for receiving signals of the wireless transmission device 25 through the wireless transmission device 25.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

what is claimed is:

1. A meter for reading measured values at remote distance, comprising:
a meter with a display screen disposed on it for displaying measured values; and
an image reading device coupled on the meter for capturing the measured values displayed on the display screen of the meter and transmitting the image to an external display device for a user to read or store at a remote distance.

2. The meter for reading measured values at remote distance as claimed in claim 1, wherein the image reading device comprises a photographing lens and a transmission line connected to the photographing lens; the photographing lens is disposed right above the display screen of the meter for capturing the measured values displayed on the display screen of the meter and transmitting the image to an external display device through the transmission line.

3. The meter for reading measured values at remote distance as claimed in claim 2, wherein the transmission line comprises a connecting interface for connecting to a display device.

4. The meter for reading measured values at remote distance as claimed in claim 2, wherein a shaft that is rotatable freely is disposed on the photographing lens.

5. The meter for reading measured values at remote distance as claimed in claim 2, wherein the image reading device further comprises a clamping element for clamping and fixing the image reading device on the meter.

6. The meter for reading measured values at remote distance as claimed in claim 1, wherein the image reading device comprises a photographing lens, a flexible tube, and a wireless transmission device; the photographing lens and the tube are connected with each other, so that the tube is able to be bent to an extent that the photographing lens is capable of capturing the measured values displayed on the display screen of the meter, and the image is transmitted to an external display device through the wireless transmission device.

7. The meter for reading measured values at remote distance as claimed in claim 1, wherein the image reading device further comprises a clamping element for clamping and fixing the image reading device on the meter.
